(19) United States
(12) Patent Application Publication
(10) Pub. No.: US 2004/0084009 A1
(43) Pub. Date: May 6, 2004

(54) Modified spiral engine

(76) Inventor: Michael Dennis Wham, Parker, CO (US)

Correspondence Address: RYAN MONTGOMERY, 140 S. WASHINGTON ST, SUITE 206, DENVER, CO, 80209, US

(21) Appl. No.: 10/436,212

(22) Filed: May 12, 2003

Related U.S. Application Data
(60) Provisional application No. 60/388,430, filed on Jun. 14, 2002.

(51) Int. Cl. F02B 53/00

(52) U.S. Cl. 123/204; 123/238; 123/246

(57) ABSTRACT

A modified spiral internal combustion engine is disclosed having a cylindrical housing, an intake end and a combustion end. A central shaft to which at least 2 spirals are attached is interposed through the housing. Fuel mixture enters the housing through an intake port and travels along the spirals toward the combustion end. The rotation of each of the spirals forms a sealed combustion chamber in the combustion end of the housing as they pass over the indentation in the end plate, which has the ignition devise. Ignition of the fuel within the chamber exerts a force on the combustion chamber portion of the spiral causing the central shaft to rotate. The rotation of the central shaft causes the combustion chamber portions of each spiral to individually pass by an exhaust port in the housing after they have ignited, allowing the spent gases to escape.

### FIELD OF THE INVENTION

The present invention relates to an internal combustion engine and more precisely to an efficient, inexpensive modified spiral engine, which is adaptable to a wide variety of applications.

### BACKGROUND OF THE INVENTION

### The Problem

Most internal combustion engines today are complex and inefficient. Gasoline powered engines contribute substantially to air pollution. Typical piston engines contain a multitude of moving parts, each capable of wearing out and ultimately failing. This in turn requires an engine to undergo extensive maintenance, thus increasing the cost of utilizing the engine. There is a need to replace the traditional internal combustion engine with a simpler, more efficient, and inexpensive alternative.

Modern replacements for the traditional piston engine such as electric and fuel cell technology systems have substantial drawbacks. They lack power, have limited range, require expensive components such as batteries, have low power to weight ratios, and require substantial downtime to regenerate/recharge.

There are viable alternatives to gasoline such as natural gas, propane, or ethanol. A very strong need exists for a simple, efficient, reliable, and versatile engine that can utilize many different types of fuel.

### PRIOR ART

Engine designs encompass 4 basic categories:

1. Rocket engines, including solid and liquid propellants,

2. Gas turbine and jet engines,

3. Piston engines, including two stroke, four stroke and diesel engines,

4. Rotary or Wankel engines.

The rocket engine contains no rotating shaft or other moving parts. It has no “sealed” combustion chamber and only one true phase, combustion. It uses force or thrust created by the rapid, controlled burning of its self-contained fuel mixture. Thrust is from the resulting high temperature and high-pressure gases escaping after combustion via a nozzle.

The turbine or jet engine also has no “sealed” combustion chamber. Intake air passes through a set of fan blades and is forced into the combustion area where fuel is injected and subsequently ignited. The combustion creates high temperature and pressure gases, which are forced over the turbine fans and out the back of the engine. Thrust is created by the increased velocity of the air forced out the back of the engine. While gas turbine engines have good power to weight ratios, they are expensive to build and maintain, since they spin at extremely high speeds and operate at very high temperatures. They do not perform well under fluctuating loads. The combustion process is very inefficient in that there is no sealed chamber and the fuel is not completely consumed. They also are a major air pollution contributor.

A piston type internal combustion engine utilizes the rotational force created from reciprocating piston assemblies moving inside a circular bore. Traditional 4-stroke engines have many moving parts including the piston, rod, crankshaft, camshaft, pushrod, rocker arms, and valves. Even 2-stroke and diesel engines have multiple moving parts, including the piston, rod, and crankshaft. Most modern cars use the 4-stroke piston engine. Diesel engines are most commonly used in trucks and 2-stroke engines are common in recreational vehicles such as motorcycles and snowmobiles.

The piston type engine loses efficiency since it converts reciprocating energy into rotational energy via the crankshaft. They also do not completely burn all of the fuel during combustion cycle. The traditional piston type engines are also major pollution contributors.

Another engine type is the rotary or Wankel engine. The rotary engine incorporates a triangular shaped rotor that spins within an oval shaped housing. In the middle of the rotor is a lobe on the output shaft, which is offset from center. As the rotor follows its irregular oval revolution, the center of the rotor pushes the lobe on the output shaft and forces the shaft to rotate. During one revolution of the rotor, the output shaft actually rotates 3 times. The rotary engine typically consumes more fuel than a similarly powered piston engine. They are inefficient due primarily to the elongated combustion chamber and low compression ratios. Manufacturers of the rotary engine have had great difficulty in meeting U.S. emission standards.

All of the foregoing engine types are relatively inefficient and are major contributors to air pollution. Except for the rocket engine, the other engine types are quite complex, containing many moving parts. All differ substantially from the present invention and, again, other engine types fail to provide a viable solution to the problem.

### The Solution

The present invention has advantages over existing engine types in that it provides an efficient spiral design and employs only one moving part to provide power. The spiral assembly itself takes the place of many moving parts in the typical internal combustion engine, making the invention simpler, more efficient, and more reliable. Reliability via less moving parts will reduce maintenance costs. Simplicity and fewer parts will reduce costs to build the engine, making the resulting product applications less expensive.

The present invention has the advantage of versatility. Multiple engines can be coupled together via the central shaft or can be coupled via belts or gear assemblies. Engines can be just as easily manufactured so that they rotate in the opposite direction. A load can be placed on either end of the central output shaft from the engine. The engines can have two or more spirals, more than one combustion chamber in the end plate with an ignition source, and any combination thereof

### SUMMARY OF THE INVENTION

The present invention differs from most internal combustion engines in that there are no flat rotors or pistons. The present invention utilizes spirals connected to a central shaft within a cylindrical housing to perform all the functions that require many different parts in a traditional engine. Parts such as camshafts, valves, pushrods, and connecting rods have been eliminated.

The present invention does not have a true compression phase. Instead, the fuel mixture has been accelerated over the length of the spiral and uses that force to fill the combustion chamber prior to being sealed by the chamber portion of the spiral. No exhaust valve is required as the spent gases are expelled as the chamber portion of the spiral passes an opening in the housing. The present invention has only one moving part, the central shaft to which the spirals are attached.

The preferred embodiment of this invention would use natural gas or propane as fuel. However, this does not preclude use of other gaseous fuels such as gasoline, ethanol, or any other viable fuel. Use of natural gas or propane would require no elaborate carburetion or fuel injection system, although such could be adapted. In fact any of the fuel accoutrements of a traditional piston engine could be adapted. Some examples include carburetors, fuel injection, turbochargers, and superchargers.

As the central shaft rotates, the fuel mixture passes along the spirals toward the other end of the housing. The speed of the fuel mixture increases along the length of the housing. This is due to the increasing width of the spirals and thus the decreasing distance between the spirals for the fuel to pass through. As the fuel mixture travels to the end of the housing, the spiral rotates and the chamber portion of the spiral seals against the chamber portion of the end plate. An ignition source in the chamber portion of the end plate ignites the fuel mixture. The pressure of the resulting explosion exerts a force on the chamber portion of the spiral, thus causing the spiral and central shaft to rotate. The spiral then rotates past the exhaust port and the spent gases are allowed to exit through the exhaust assembly. Simultaneously, the chamber portion of the second spiral passes over and seals against the chamber portion of the end plate and the ignition/force/rotation/exhaust cycle is repeated.

The preferred embodiment of the present invention contemplates spirals having a pitch angle that enables the spirals to each have a complete twist over the entire length of the engine. A different embodiment of the present invention presents an engine that can be shortened so that the spirals complete less than a full twist. However, the spirals should not have a helical twist less than 1/4 in order to properly form and seal the combustion chamber.

Another embodiment of the instant invention has three or more spirals. This would create the same number of combustion cycles per revolution as spirals using an endplate with a single combustion chamber recess and ignition device.

Yet another embodiment of the present invention has two or more combustion chamber recesses in the end plate. Each chamber would have its own exhaust port assembly and ignition device. For example, an embodiment with 3 spirals and 2 end plate combustion chambers would have 6 combustion cycles per revolution, substantially increasing the output of the engine. These alternate embodiments can be combined to form many different versions of the basic engine.

A still further embodiment of the engine allows coupling two or more engines together. Multiple engines could be placed in tandem using the central shaft. Note that the spiral engines could be manufactured in such a way that spirals would twist in the opposite direction. This would allow flexibility in facing the engines when coupled together. This coupling flexibility would also permit stacking several engines together in a parallel series. Multiple engines could be coupled together via a belt or gear assembly on the end. This embodiment would allow, for instance, multiple engines to be coupled individually via belt or gear, or several engines coupled via a central shaft could in turn be coupled to a similar arrangement of engines, also via belt or gears.

Another embodiment allows for a pass-through port in the combustion end of the engine that permits unused fuel mixture from one engine to pass through the end plate and enter the intake end of another engine to thus power that engine. A still further alternative of this embodiment allows for more than one pass-through port to power additional engines.

### BRIEF DESCRIPTION OF THE DRAWINGS

FIG. 1 shows a side view of the engine

FIG. 2 shows an end view of the spiral assembly from the combustion end

FIG. 2B shows a top view of the spiral assembly from the combustion end

FIG. 3 shows an end view of the central shaft, combustion chamber, and an ignition source in the end plate at the combustion end

FIG. 4 shows a 3 dimensional view of the combustion end of the spiral assembly

FIG. 5 shows a detailed view of the intake end of the engine

FIG. 6 shows a detailed view of the combustion chamber end of the engine

FIG. 7 shows an inside end view of the combustion chamber portion of the end plate for auxiliary pass-through ports for additional engines

FIG. 8 shows an end view of the combustion end of the spiral assemblies in the alternative embodiment of the engine with three spirals

FIG. 9 shows an inside view of the end plate at the combustion end of alternative embodiment with two combustion chambers

FIG. 10 shows two engines coupled via a single central shaft

FIG. 10B shows two engines coupled using a pass-through port intake system in the second engine

FIG. 11 shows four engines coupled in tandem via a central shaft

FIG. 12 shows an engine stack having a number of engines coupled together in tandem via a central shaft and in parallel via a belt system

FIG. 13 shows an alternative embodiment of the engine with spirals of less than a complete helical twist over the length of the engine

### DETAILED DESCRIPTION OF THE PREFERRED EMBODIMENTS

It is the object of the present invention to provide an efficient internal combustion modified spiral engine.

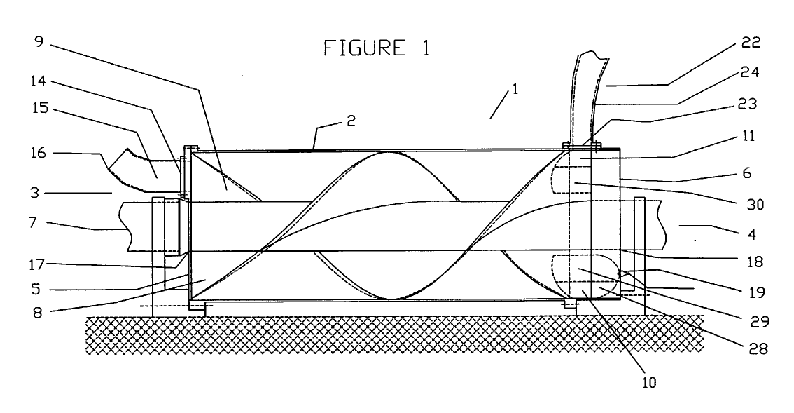

FIG. 1 shows the basic spiral engine 1. The preferred embodiment of the present invention has a hollow cylindrical housing 2. The hollow housing has an intake end 3 and a combustion end 4. Both the intake end 3 and the combustion end 4 have end plates 5 and 6. Carved into the combustion end plate 6 is combustion recess 28. The housing 2 contains a cylindrical central shaft 7 disposed within and through the length of the housing 2. Two spirals 8 and 9 are attached to the central shaft 7 along its length and extend out from the central shaft 7 toward the housing 2. The spirals 8 and 9 have a diameter that brings them into close proximity with the interior of the housing 2.

The end plates 5 and 6 have orifices 17 and 18 that allow the cylindrical shaft 7 to pass through and on to any exterior components carrying a load. The spirals 8 and 9 have an increasing width from the intake end 3 to the combustion end 4. Cuffs 10 and 11 are attached to outside diameter edges of spirals 8 and 9 near the combustion end 4. Cuff 10 connects the leading edge of spiral 9 with the following edge of spiral 8 and cuff 11 connects the leading edge of spiral 8 with the following edge of spiral 9.

The intake end 3 has an intake orifice 14 coupled by an intake assembly 15 that has an intake tube 16, where a fuel mixture enters the housing 2. The rotation of the central shaft 7 and spirals 8 and 9 causes fuel mixture to pass through the housing 2. The speed at which the fuel mixture travels increases from the intake end 3 toward the combustion end 4, due to the decreasing distance between spirals 8 and 9.

In the combustion phase, the rotation of the central shaft 7 and attached spirals 8 and 9 forces fuel mixture into the combustion chamber recess 28 in end plate 6. Combustion chamber portion 29 of spiral 8 seals the combined chamber of 28+29 as central shaft 7 and spiral 8 continue to rotate. The ignition device 19 ignites the fuel mixture in the sealed combined chamber 28+29. The combustion of the fuel mixture exerts a force on the combustion chamber portion 29 of spiral 8 causing central shaft 7 to rotate.

In the exhaust phase, the combustion chamber portion 29 of spiral 8 moves toward the exhaust assembly 22. As the combustion chamber portion 29 passes the exhaust orifice 23, spent gases exit through exhaust pipe 24.

While the exhaust phase for spiral 8 is occurring, the combustion phase for spiral 9 is occurring. This phase mimics that which occurred for spiral 8. Gas is forced into the combustion chamber recess 28. Combustion chamber portion 30 of spiral 9 seals the combined chamber of 28 and 30 and ignition device 19 ignites the fuel mixture. Resulting explosion, force on 30, rotation of shaft 7, and passing the exhaust assembly 22 by spiral 9 are the same process as occurred with spiral 8, with cycles continuing indefinitely.

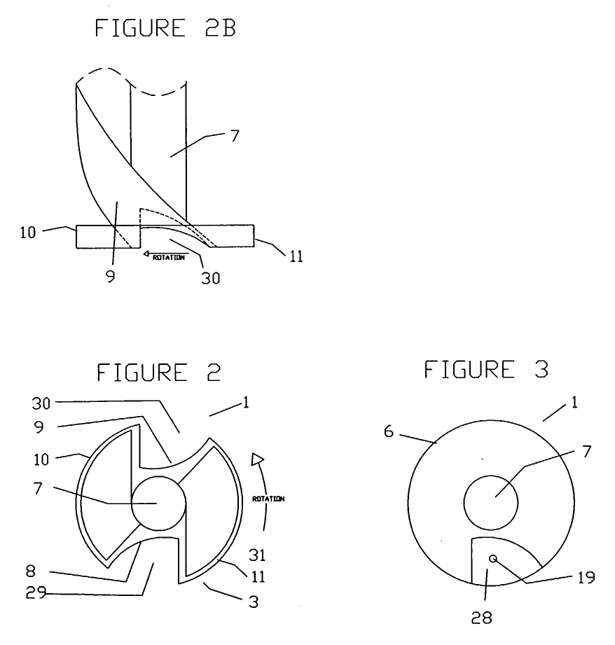

As illustrated in FIG. 2 this end view shows the combustion end of the spirals 8 and 9 and central shaft 7. The combustion chamber portions 29 and 30 of the spirals formed the combined chambers 28 and 29 and 28 and 30 respectively as they rotate into position with the combustion chamber recess 28. Cuffs 10 and 11 are connected to the edges of spirals 8 and 9 and are wider than the exhaust orifice 23. Cuffs 10 and 11 serve to seal exhaust orifice 23 closed so that unused fuel gas between spirals 8 and 9 cannot escape. FIG. 2B shows the cuffs 10 and 11 as they attach to spiral 9 and are open for the top of chamber 30. Spent gases from combustion chamber 30 will escape through exhaust orifice 23 when the opening at top of chamber 30 and orifice 23 align.

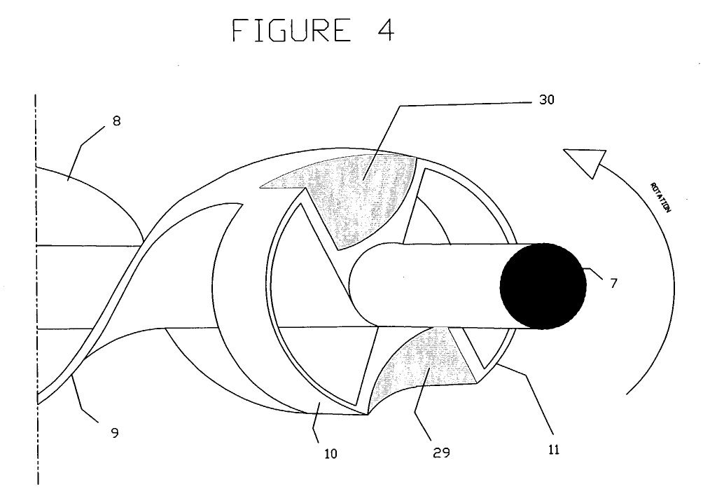

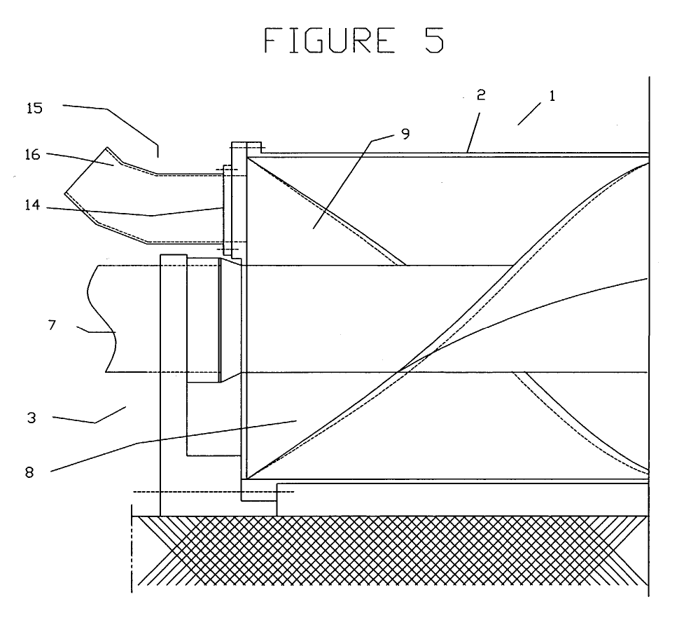

FIG. 3 shows an end view of the combustion end 4, central shaft 7, combustion end plate 6, with combustion chamber recess 28 and placement of the ignition device 19 therein. FIG. 4 is a 3 dimensional view that illustrates the relationship of spirals 8 and 9 to the central shaft 7 and the relationships of cuffs 10 and 11 to spirals 8 and 9.

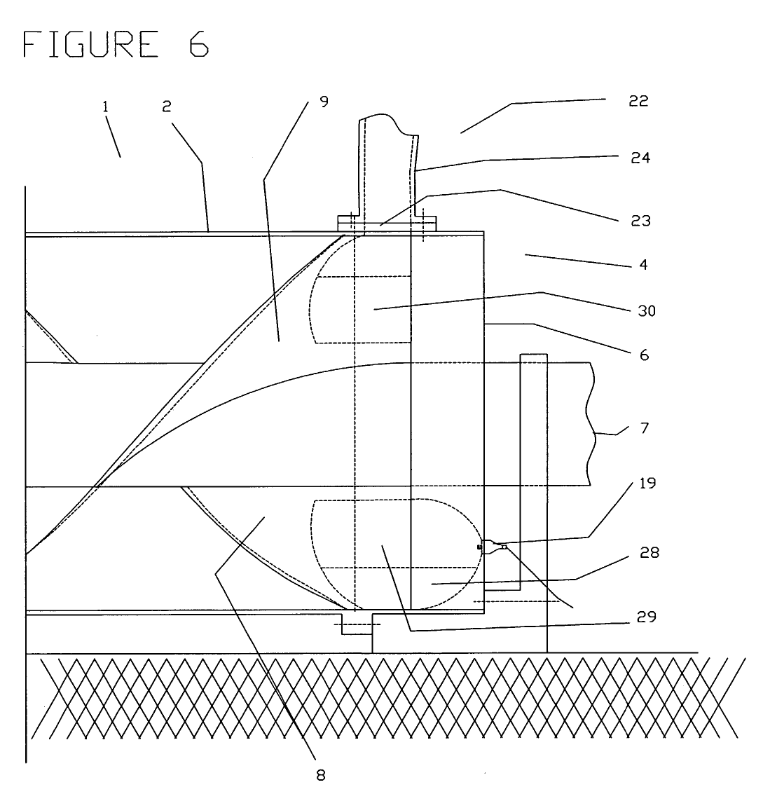

FIG. 5 is a somewhat enlarged view of the intake end 3 of the engine 1 and part of the housing 2. Fuel mixture enters through the intake assembly 15 and into the housing 2 through intake orifice 14. Fuel mixture then passes along the spirals 8 and 9 as the central shaft rotates.

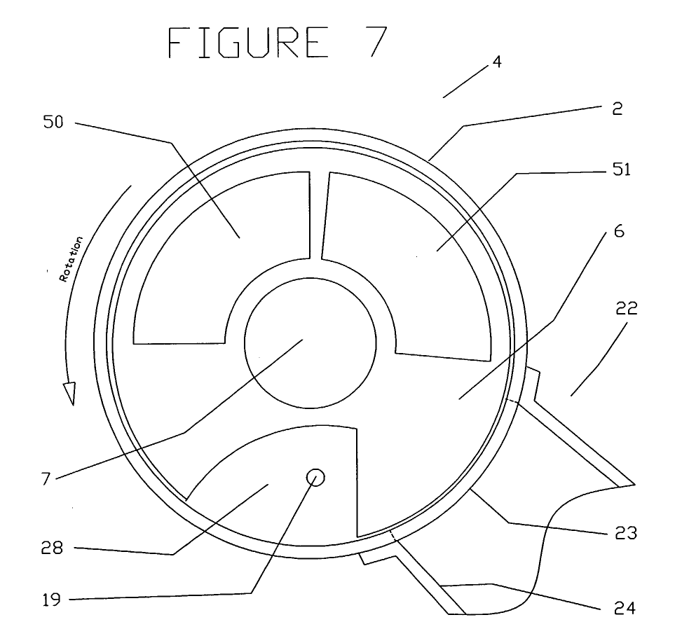

FIG. 6 is an enlarged view of the combustion end 4 of engine 1. It illustrates the combustion and exhaust phases of the engine. Fuel mixture passes along spiral 8, is sealed into the combined combustion chamber 28 and 29 and is ignited by ignition device 19. Resulting force is applied to chamber portion 29 of spiral 8, causing rotation of central shaft 7. Chamber portion 29 of spiral 8 then passes by the exhaust orifice 23 and spent gasses are allowed to exit via the exhaust assembly 22.

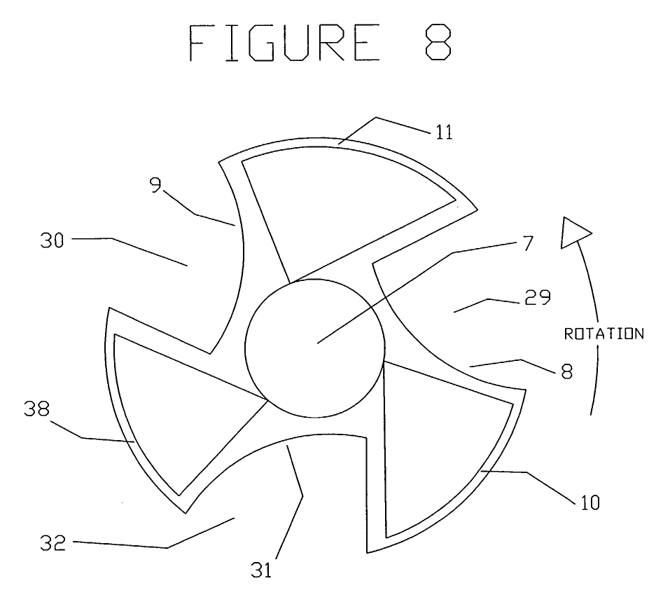

FIG. 7 shows the end view of an alternative embodiment of the present invention from the combustion end 4. In this embodiment, pass-through ports 50 and 51 are formed in the end plate. The pass-through ports 50 and 51 allow excess, unused fuel mixture to pass to additional spiral engines. This embodiment would be especially useful in the coupling of multiple engines in tandem. The pass-through ports are located on the opposite side of the endplate 6, away from the combustion chamber recess 28 and ignition source 19, so as to not impede the combustion cycles. This embodiment requires that the exhaust assembly 22 be situated next to the combustion chamber recess 28 so that exhaust gasses have been removed prior to combustion chamber portions 29 and 30 of spirals 8 and 9 passing by the pass-through ports 50 and 51.

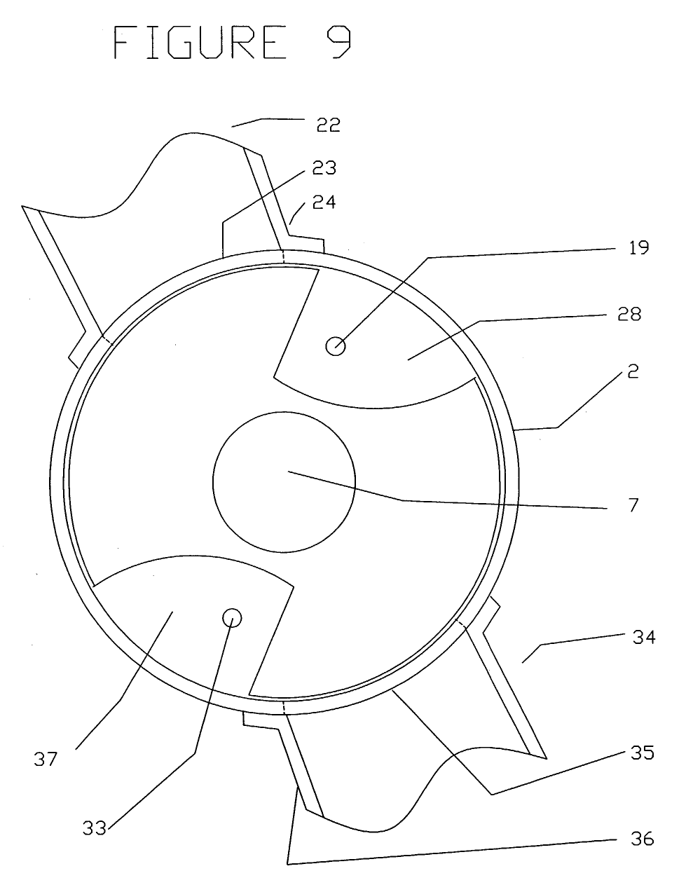

FIG. 8 illustrates a further embodiment of the present invention. It employs an additional spiral 31 that forms a further additional combustion chamber portion 32 and the cuff 38. Cuff 38 connects the leading edge of spiral 9 with the trailing edge of spiral 31. Cuff 10 now connects the trailing edge of spiral 8 with the leading edge of spiral 31.

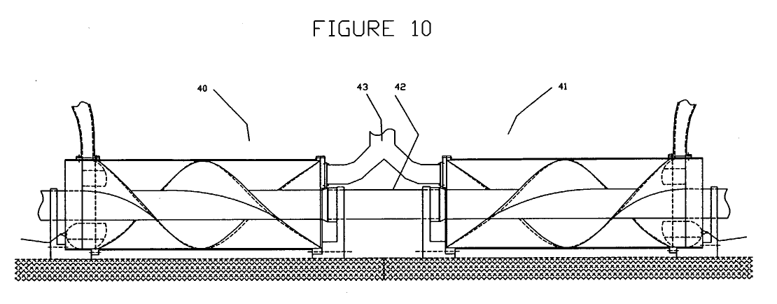

FIG. 9 illustrates a still further embodiment, which includes an additional combustion chamber recess 37, an additional ignition device 33, and an additional exhaust assembly 34 with orifice 35 and exhaust pipe 36.

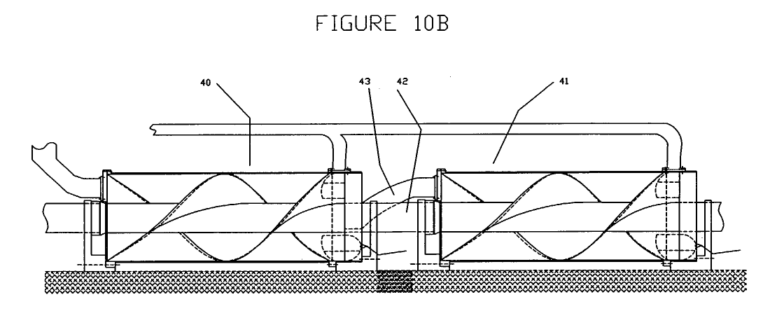

FIG. 10 illustrates two engines 40 and 41 coupled via a single central shaft 42 and a single bifurcated intake assembly 43. FIG. 10B illustrates two engines 40 and 41 coupled via a central shaft 42 and using pass-through intake 43.

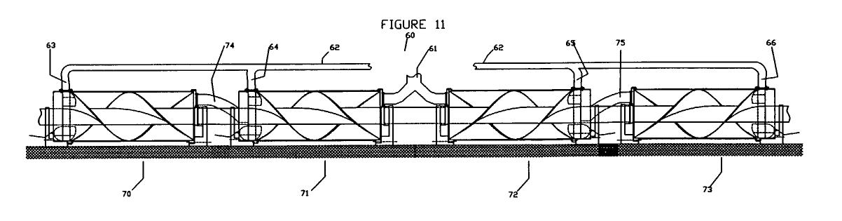

FIG. 11 shows an engine assembly 60 having engines 70, 71, 72, and 73 coupled together via a central shaft and using pass-through ports 74 and 75 to provide fuel for engines 70 and 73. The engine assembly 60 has a bifurcated intake assembly 61 and an exhaust assembly 62 which includes exhaust ports 63, 64, 65, and 66 from each engine.

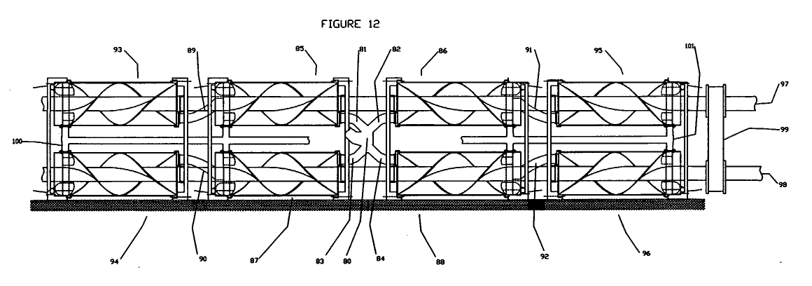

FIG. 12 illustrates how several engines may be stacked in parallel. In this embodiment, a central intake assembly 80 engages intake tubes 81, 82, 83, and 84 which are connected to the inner engines 85, 86, 87, and 88. The combustion ends of the inner engines have pass-through ports 89, 90, 91, and 92 that allow unused fuel to pass to outer engines 93, 94, 95, and 96. Common exhaust assemblies 100 and 101 evacuate spent gasses to the atmosphere. Two central shafts 97 and 98 are coupled together by a belt 99.

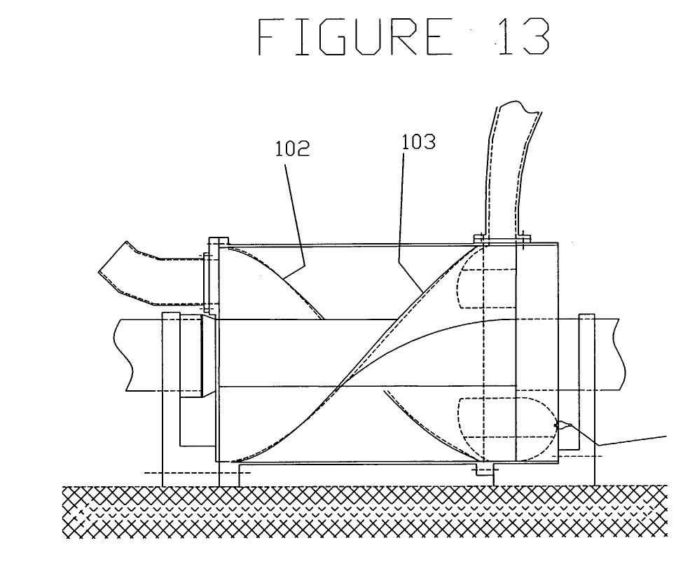

FIG. 13 shows how any of the above engines can be shortened. It contains spirals 102 and 103 having a helical turn of less than one twist, but not less than one-quarter twist.

In as much as the present invention is subject to numerous variations, modifications and changes in its details, it is intended that all of the embodiments described herein are for illustrative purposes only. Thus, although the description above contains many specificities, these should not be construed as limiting the scope of the invention but as merely providing illustration of some of the presently preferred embodiments of this invention. Therefore, it is intended that the invention be limited only to the spirit and scope of the hereto-appended claims.

What is claimed is:

1. A modified spiral engine, comprising:
A cylindrical housing having an intake end plate and a combustion end plate; a central shaft interposed through said intake end plate and through said combustion end plate; at least two spirals attached to said central shaft extending from said intake end plate to said combustion end plate; at least one intake port formed in said intake end plate to allow fuel to enter said housing; at least one combustion chamber formed by rotation of said central shaft and said spirals, whereby said combustion chamber is sealed by rotation of one of said spirals against said combustion end plate; at least one ignition source situated in said combustion end plate for ignition of fuel; at least one exhaust port situated on said housing whereby spent gasses escape said housing and said combustion chamber after combustion by virtue of rotation of said central shaft.

2. The modified spiral engine of claim 1, wherein said spirals increase in width from said intake end plate towards said combustion end plate, whereby any fuel passing along said spirals is accelerated.

3. The modified spiral engine of claim 1, further comprising: at least one auxiliary pass-through port formed in said combustion end plate whereby any additional volume of unused fuel mixture forced along said spirals is passed through to additional engine units.

4. The modified spiral engine of claims 1, 2, or 3, in which said central shaft and said housing are shortened whereby said spirals have helical turn of not more than a full twist and not less than 1/4 twist.

5. The modified spiral engine of claim 3, having means for coupling a plurality of additional said engines in tandem, whereby said auxiliary port allows fuel mixture to pass to said additional coupled engines.

6. The modified spiral engine of claim 5, wherein said spirals increase in width from said intake end plate towards said combustion end plate, whereby any fuel passing along said spirals is accelerated.

7. The modified spiral engine of claims 5 or 6, in which said central shaft and said housing are shortened whereby said spirals have a helical turn of not more than a full twist and not less than one-quarter twist.

8. The modified spiral engine of claim 3, having means for coupling a plurality of additional said engines in parallel.

9. The modified spiral engine of claim 8, wherein said spirals increase in width from said intake end plate toward said combustion end plate, whereby any fuel passing along said spirals is accelerated.

10. The modified spiral engine of claims 8 or 9, in which said central shaft and said housing are shortened whereby said spirals have a helical turn of not more than a full twist and not less than one-quarter twist.
